(19) United States
(12) Patent Application Publication
(10) Pub. No.: US 2016/0039961 A1
(43) Pub. Date: Feb. 11, 2016

(54) MONODISPERSE MICROSPHERES AND METHOD OF PREPARING SAME

(71) Applicant: THE REGENTS OF THE UNIVERSITY OF COLORADO, A BODY CORPORATE, BOULDER, CO (US)

(72) Inventors: CHRISTOPHER N. BOWMAN, BOULDER, CO (US); CHEN WANG, BOULDER, CO (US)

(21) Appl. No.: 14/815,548

(22) Filed: Jul. 31, 2015

Related U.S. Application Data
(60) Provisional application No. 62/033,299, filed on Aug. 5, 2014.

(51) Int. Cl. C08F 228/02; C08L 39/06; C08L 33/14

(52) U.S. Cl. CPC C08F 228/02; C08L 33/14; C08L 39/06

(57) ABSTRACT

The present invention includes microspheres prepared using step-growth dispersion click chemistry polymerization. In certain embodiments, the click chemistry polymerization comprises thiol-ene polymerization and/or thiol-Michael polymerization. In other embodiments, the microspheres are near-monodisperse and/or monodisperse. In yet other embodiments, the microspheres have a glass transition temperature (Tg) in the range of −50° C. to 100° C. The present invention further includes a method of making the same.

### CROSS-REFERENCE TO RELATED APPLICATIONS

The present application claims priority under 35 U.S.C. §119(e) to U.S. Provisional Patent Application No. 62/033,299, filed Aug. 5, 2014, which application is incorporated herein by reference in its entirety.

### STATEMENT REGARDING FEDERALLY SPONSORED RESEARCH OR DEVELOPMENT

This invention was made with government support under grant number CHE1214109 awarded by the National Science Foundation. The government has certain rights in the invention.

### BACKGROUND OF THE INVENTION

Microspheres, sometimes referred to as microparticles, are materials with diameters in the range of 1 μm to 1,000 μm, high specific surface area and high diffusivity. Microspheres are ubiquitous in coatings, composites, drug delivery, separations, and many other applications (Kawaguchi, et al., Prog. Polym. Sci., 2000, 25:1171-1210; Jeong, et al., Nature, 1997, 388:860-862; Wang, et al., Angew. Chem., Int. Ed., 2003, 42:5336-5338). Further, monodisperse microspheres have unique applications in chromatography, photonic crystals, micro-devices and biomedical analysis (Wang, et al., Angew. Chem., Int. Ed., 2003, 42:5336-5338; Terray, et al., Science, 2002, 296:1841-1844; Deutsch, et al., Adv. Mater., 2000, 12:1176-1180.

Recently, monodisperse microspheres, particularly those with groups capable of covalently bind to ligands, are finding increasing uses in separation processes such as affinity chromatography, labeling and cancer research. One example of the applications is SIR-Sphere microspheres, which are radioactive polymer spheres that emit beta radiation and can be delivered directly to the tumor site (Rajput, et al., Indian J. Cancer 2010,47(4):458-468). In this way, the microspheres function as a targeted drug delivery vehicle, without causing significant side effects on normal cells, in contrast to conventional methods.

Microspheres prepared by free-radical chain-growth polymerization, including microspheres made from polystyrene and poly(methyl methacrylate) (Zhao, et al., Macromolecules, 1996, 29:7678-7682; Sivakumar, et al., React. Funct. Polym., 2000, 46:29-37), have been extensively studied. On the contrary, industrial step-growth polymers, such as polyamides and polycarbonates, have rarely been used in microsphere preparation.

Polymerization reactions will take place only once initiation occurs. In the case of step-growth reactions, polymerization requires the presence of the reactive species, often a catalytic base, nucleophile or metal ion. However, for this type of polymerization, the rate decelerates dramatically with increasing reactant consumption, generally compromising the final conversion and preventing the formation of appropriately reacted and stable particles. The presence of an uncontrolled amount of residual, unreacted groups within the microspheres is highly problematic, leading to aggregation and numerous other problems. In chain-growth linear polymerizations, aliphatic main chains are typically generated from the reaction of a carbon-carbon double bond, leading to heterogeneous networks. On the other hand, in step-growth systems the polymer backbone incorporates linking groups, which generate structurally uniform networks (Hoyle, et al., Angew. Chem., Int. Ed., 2010, 49:1540-1573; Gong, et al., Adv. Mater., 2013, 14:2024-2028). Moreover, in step-growth polymerizations, a specific, controlled amount of unreacted functional groups may remain available for further intrinsic functionalization after off stoichiometric polymerizations.

Thiol-click chemistries have been widely used in dendrimer synthesis, polymer coupling, polymer functionalization and network formation due to their rapid kinetics and high product yields (Hoyle, et al., Angew. Chem., Int. Ed., 2010, 49:1540-1573). Thus, there is a need in the art to develop novel microspheres via step-growth polymerization, allowing for their use in challenging applications, such as coatings, composites, drug delivery, and chromatography. The present invention fulfills these needs.

### BRIEF SUMMARY OF THE INVENTION

The invention includes microspheres comprising a polymer which is prepared using step-growth dispersion click chemistry polymerization. The invention further includes polymeric composites comprising microspheres of the invention. The invention further includes methods of preparing microspheres of the invention.

In certain embodiments, the click chemistry polymerization comprises thiol-ene polymerization. In other embodiments, the click chemistry polymerization comprises thiol-Michael polymerization. In yet other embodiments, the microspheres have an average diameter within a range selected from the group consisting of: from 0.5 μm to 100 μm, from 1 μm to 50 μm, from 0.5 μm to 1 μm; and from 1 μm to 10 μm. In yet other embodiments, the microspheres are near-monodisperse. In yet other embodiments, the microspheres are monodisperse.

In certain embodiments, the microspheres have a glass transition temperature (Tg) in the range of −50° C. to 100° C. In other embodiments, the microspheres have a Tg in the range of −24° C. to 16° C. In yet other embodiments, the microspheres have unreacted functional groups which are functionalizable. In yet other embodiments, at least one microsphere has unreacted functional groups which are functionalizable. In yet other embodiments, the microspheres are degradable in acidic or basic media. In yet other embodiments, at least one microsphere is degradable in acidic or basic media. In yet other embodiments, the microspheres are labeled. In yet other embodiments, at least one microsphere is labeled.

In certain embodiments, the thiol monomer is selected from a group consisting of pentaerythritol tetramercaptopropionate (PETMP); ethylene glycol bis(3-mercaptopropionate) (EGBMP); trimethylolpropane tris(3-mercaptopropionate)(TMPMP); 2,4,6-trioxo-1,3,5-triazina-triy (triethyl-tris (3-mercapto propionate); 1,2-ethanedithiol; 1,3-propanedithiol; 1,4-butanedithiol; 1,5-pentanedithiol; 1,6-hexanedithiol; 1,8-octanedithiol; 1,9-nonanedithiol; 1,11-undecanedithiol; 1,16-hexadecanedithiol; 2,5-dimercaptomethyl-1,4-dithiane, pentaerythritol tetramercaptoacetate, trimethylolpropane trimercaptoacetate, glycol dimercaptoacetate, 2,3-dimercapto-1-propanol, DL-dithiothreitol; 2-mercaptoethylsulfide, 2,3-(dimercaptoethylthio)-1-mercaptopropane, 1,2,3-trimercaptopropane, toluenedithiol, benzenedithiol, biphenyldithiol, benzenedimethanethiol, xylylenedithiol, 4,4′-dimercaptostibene and glycol dimercaptopropionate.

In certain embodiments, the ene monomer is selected from a group consisting of ethylene glycoldi(meth)acrylate, ethoxylated bisphenol-A dimethacrylate (EBPADMA), tetraethyleneglycoldi(meth)acrylate (TEGDMA), poly(ethylene glycol) dimethacrylates, the condensation product of bisphenol A and glycidyl methacrylate, 2,2′-bis-[4-(3-methacryloxy-2-hydroxy propoxy)-phenyl] propane (BisGMA), hexanediol di(meth)acrylate, tripropylene glycol di(meth)acrylate, butanediol di(meth) acrylate, neopentyl glycol di(meth) acrylate, diethylene glycol di(meth)acrylate, triethylene glycol di(meth) acrylate, dipropylene glycol di(meth)acrylate, trimethylolpropane triacrylate (TMPTA), di(trimethylolpropane) tetraacrylate

(DTPTA), divinyl sulfone (DVS), propargyl acrylate, 6-azidohexyl acrylate, [2-(acryloyloxy)ethyl]trimethylammonium chloride, acrylic acid, 2-(4-benzoyl-3-hydroxyphenoxy)ethyl acrylate, 3-sulfopropyl acrylate potassium salt, 2-hydroxyethyl acrylate and 2-(dimethylamino)ethyl acrylate.1,1′-(Methylenedi-4,1-phenylene)bismaleimide, 1,4-di(maleimido)butane, N,N′-phenylenedimaleimide, and N,N′-methylenebisacrylamide.

In certain embodiments, the method comprises contacting a thiol monomer and an ene monomer with an organic solvent to form a reaction system. In other embodiments, the method comprises promoting the reaction of the thiol monomer and the ene monomer to form a polymer, wherein the polymer is insoluble in the reaction system, whereby the microspheres separate from the reaction system. In yet other embodiments, the reaction system further comprises a surfactant. In yet other embodiments, the surfactant comprises at least one selected from the group consisting of polyvinylpyrrolidone (PVP), poly(ethylene glycol), poly(vinyl alcohol), poly(styrene-co-maleic anhydride), poly(acrylic acid), poly(vinyl alcohol-co-vinyl acetate), and polyacrylamide. In yet other embodiments, the surfactant stabilizes the polymer within the microspheres.

In certain embodiments, the organic solvent comprises methanol, ethanol, isopropanol, butanol, a methanol/water mixture, a methanol/hexane mixture, a methanol/heptane mixture, a methanol/cyclohexane mixture, an ethanol/water mixture, an ethanol/hexane mixture, an ethanol/heptane mixture, an ethanol/cyclohexane mixture, ethyl acetate, butyl acetate, acetone, methyl ethyl ketone, acetonitrile, toluene, tetrahydrofuran, 1,4-dioxane; or any mixture of two or more of the above mentioned solvents.

### BRIEF DESCRIPTION OF THE DRAWINGS

For the purpose of illustrating the invention, there are depicted in the drawings certain embodiments of the invention. However, the invention is not limited to the precise arrangements and instrumentalities of the embodiments depicted in the drawings.

FIG. 1, comprising panels A-C, illustrates SEM images of microspheres prepared by thiol-Michael addition dispersion polymerization of stoichiometric PETMP and TMPTA in methanol, with various amount of hexylamine as the initiator: (Panel A) 1.6 wt %; (Panel B) 4.0 wt %; (Panel C) 10.0 wt % hexylamine with respect to the mass of monomers. Polymerization conditions: PETMP (3.66 g, 7.5 mmol), TMPTA (3.0 g, 10 mmol), PVP (1.5 g) and methanol (150 mL), the mixture was stirred at 400 RPM for 2 h after the addition of hexylamine. The scale bar length is 10 mm.

FIG. 2 is a graph illustrating dynamic mechanical analysis of polymeric composite of PETMP-DVS microspheres in TMPTMP-TMPTA matrix. The composite comprised 0.5 g of PETMP-DVS microspheres (42 wt %) embedded in 0.7 g of TMPTMP-TMPTA matrix (58 wt %).

FIGS. 3A-3C are a set of graphs and images illustrating non-limiting aspects of the present invention. FIG. 3A is a set of graphs graph illustrating FT-IR spectra of functionalized PETMP-TMPTA microspheres prepared under 4 different conditions: (panel 1) thiol-excess (33 mol %); (panel 2) acrylate-excess (20 mol %); (panel 3) azide-functionalized (with 10 mol % azide with respect to thiol functionality); (panel 4) alkyne-functionalized (with 15 mol % alkyne with respect to thiol functionality). FIG. 3B is an image illustrating rhodamine B labeled thiol excess PETMP-TMPTA microspheres (60× objective). FIG. 3C is an image illustrating rhodamine 110 labeled alkyne-functionalized PETMP-TMPTA microspheres.

FIG. 4 is a graph illustrating UV-vis spectra of the solution from the degradation of rhodamine B labeled PETMP-TMPTA microspheres in various conditions.

FIG. 5 is a set of ¹H NMR spectra of thiol-Michael addition polymerization in CD₃OD: 0.122 g PETMP (0.25 mmol), 0.10 g TMPTA (0.33 mmol), 0.05 g PVP, 5 mL CD₃OD. A drop of hexylamine was added (12 mg) and the NMR spectrum of the dispersion was taken immediately.

FIG. 6, comprising panels A-E, illustrates SEM images of thiol-Michael dispersion polymerization with various monomers: (Panel A) EGBMP and TMPTA; (Panel B) TMPTMP and TMPTA; (Panel C) PETMP and TMPTA; (Panel D) PETMP and DTPTA; (Panel E) PETMP and DVS. Polymerization condition for all experiments: 30 mmol for both thiol and acrylate (vinyl sulfone) functional groups, 1.5 g PVP, 150 mL MeOH and 60 mg of hexylamine added under 400 rpm stirring.

FIG. 7 is a graph illustrating DSC curves of thiol-Michael microspheres made from various monomers.

FIGS. 8A-8B area set of SEM images illustrating thiol-Michael dispersion polymerization with alkyne and azide functionality. FIG. 8A is the SEM image of alkyne-functionalized microspheres; FIG. 8B is the SEM image of azide-functionalized microspheres. Polymerization condition for all experiments: PETMP (2.44 g, 5 mmol) and TMPTA (2.0 g, 6.7 mmol), propargyl acrylate (0.33 g, 3 mmol, for alkyne-functionalized microspheres), propargyl acrylate (0.33 g, 3 mmol, for alkyne-functionalized microspheres, 6-azidohexyl acrylate (0.38 g, 2 mmol, for azide-functionalized microspheres), 1.5 g PVP, 150 mL MeOH and 0.1 g of TEA added under 400 rpm stirring for 2 h.

### DETAILED DESCRIPTION OF THE INVENTION

The present invention relates to the unexpected discovery of novel monodisperse microspheres comprising a polymer which is prepared using step-growth dispersion click chemistry polymerization. The invention provides compositions comprising such monodisperse microspheres and method of preparing the same.

### Definitions

As used herein, each of the following terms has the meaning associated with it in this section.

Unless defined otherwise, all technical and scientific terms used herein generally have the same meaning as commonly understood by one of ordinary skill in the art to which this invention belongs. Generally, the nomenclature used herein and the laboratory procedures in cell culture, molecular genetics, and organic chemistry are those well-known and commonly employed in the art.

As used herein, the articles “a” and “an” refer to one or to more than one (i.e. to at least one) of the grammatical object of the article. By way of example, “an element” means one element or more than one element.

As used herein, the term “about” will be understood by persons of ordinary skill in the art and will vary to some extent on the context in which it is used. As used herein when referring to a measurable value such as an amount, a concentration, a temporal duration, and the like, the term “about” is meant to encompass variations of ±20% or ±10%, more preferably ±5%, even more preferably ±1%, and still more preferably ±0.1% from the specified value, as such variations are appropriate to perform the disclosed methods.

As used herein, the term “alkene monomer” or “alkene-based substrate” refers to a small molecule or a polymeric molecule comprising at least one reactive alkenyl group. An “alkenyl group” is an unsaturated, linear or branched or cyclic hydrocarbon group consisting at least one carbon-carbon double bond. In certain embodiments, the ene-based substrate comprises at least one alkenyl group (C═C).

As used herein, the term “alkyne monomer” or “alkyne-based substrate” refers to a small molecule or a polymeric molecule comprising at least one reactive alkynyl group. An “alkynyl group” is an unsaturated, linear or branched or cyclic hydrocarbon group consisting at least one carbon-carbon triple bond. In certain embodiments, the alkyne-based substrate comprises at least one terminal alkynyl group (—CCH).

As used herein, the term “chain-growth polymerization” refers to a type of polymerization mechanism wherein unsaturated monomer molecules add onto the active site of a growing polymer chain one at a time. In chain-growth linear polymerizations, aliphatic main chains are typically generated from the reaction of a carbon-carbon double bond.

As used herein, the term “click chemistry” refers to a chemical synthesis method that generates products quickly and reliably by joining small units under mild condition. Non-limiting examples include [3+2] cycloadditions, such as the Huisgen 1,3-dipolar cycloaddition; thiol-ene click reactions; Diels-Alder reaction and inverse electron demand Diels-Alder reaction; [4+1] cycloadditions between isonitriles (isocyanides) and tetrazines; nucleophilic substitution especially to small strained rings like epoxy and aziridine compounds; addition reactions to carbon-carbon double bonds like dihydroxylation or the alkynes in the thiol-yne reaction.

As used herein, the terms “comprising,” “including,” “containing” and “characterized by” are exchangeable, inclusive, open-ended and does not exclude additional, unrecited elements or method steps. Any recitation herein of the term “comprising,” particularly in a description of components of a composition or in a description of elements of a device, is understood to encompass those compositions and methods consisting essentially of and consisting of the recited components or elements.

As used herein, the term “consisting of” excludes any element, step, or ingredient not specified in the claim element.

As used herein, the term “consisting essentially of” does not exclude materials or steps that do not materially affect the basic and novel characteristics of the claim.

As used herein, the term “ene monomer” refers to a monomer comprising at least one reactive alkene group.

As used herein, term “functionalizable microspheres” refers to microspheres having unreacted functional groups, enabling further functionalization if needed.

As used herein, the term “label” as applied to a microsphere refers to a chemical group that is covalently coupled with a microsphere, wherein the chemical group allows for the detection and/or further derivatization of the microsphere. Non-limiting examples of labels contemplated within the invention include fluorescent molecules, molecules comprising one or more “clickable” groups, magnetic moieties (such as iron oxide nanoparticles coated with one or more “clickable groups”), molecules comprising at least one radioactive isotope, and the like.

As used herein, the term “monodisperse” means that microspheres are substantially uniform in size, shape and mass. In certain embodiments, a monodisperse suspension of nanoparticles contains particles of nearly the same size, forming a narrow distribution about an average value, whereas a polydisperse suspension contains particles of different sizes, forming a broad distribution.

In certain embodiments, near-monodisperse nanoparticles have equal to or less than about 15% coefficient of variation. In other embodiments, monodisperse nanoparticles have equal to or less than about 5% coefficient of variation (that is, CV=σ/d<5%, where σ and d are the standard deviation and the mean size, respectively). In yet other embodiments, the monodisperse nanoparticles have equal to or less than about 5%, 2%, or 1%.

The term “monomer” refers to any discreet chemical compound of any molecular weight.

As used herein, the term “polymer” refers to a molecule composed of repeating structural units typically connected by covalent chemical bonds. The term “polymer” is also meant to include the terms copolymer and oligomers. In certain embodiments, a polymer comprises a backbone (i.e., the chemical connectivity that defines the central chain of the polymer, including chemical linkages among the various polymerized monomeric units) and a side chain (i.e., the chemical connectivity that extends away from the backbone).

As used herein, the term “polymerization” or “crosslinking” refers to at least one reaction that consumes at least one functional group in a monomeric molecule (or monomer), oligomeric molecule (or oligomer) or polymeric molecule (or polymer), to create at least one chemical linkage between at least two distinct molecules (e.g., intermolecular bond), at least one chemical linkage within the same molecule (e.g., intramolecular bond), or any combinations thereof. A polymerization or crosslinking reaction may consume between about 0% and about 100% of the at least one functional group available in the system. In certain embodiments, polymerization or crosslinking of at least one functional group results in about 100% consumption of the at least one functional group. In other embodiments, polymerization or crosslinking of at least one functional group results in less than about 100% consumption of the at least one functional group.

As used herein, the term “reaction condition” refers to a physical treatment, chemical reagent, or combination thereof, which is required or optionally required to promote a reaction. Non-limiting examples of reaction conditions are electromagnetic radiation, heat, a catalyst, a chemical reagent (such as, but not limited to, an acid, base, electrophile or nucleophile), and a buffer.

As used herein, the term “reactive” as applied to thiol, azide, alkyne or alkene groups indicate that these groups under appropriate conditions may take part in one or more reactions as defined in this application.

As used herein, “step-growth polymerization” refers to a type of polymerization mechanism wherein bifunctional or multifunctional monomers react first to form dimers, then trimers, then eventually long chain polymers. In the event of multi-functional monomers, crosslinked polymers are produced.

As used herein, the term “thiol-click chemistry” refers to click chemistry wherein a thiol is one of the reactants.

As used herein, the term “thiol-ene reaction” refers to an organic reaction between a thiol monomer and an ene monomer. In certain embodiments, the ene monomer is an α,β-unsaturated ester, acid, sulfone, nitrile, ketone, amide, aldehyde, or nitro compound (Hoyle, et al., Angew. Chem. Intl Ed., 2010, 49(9):1540-1573); the thio-ene reaction involving such reactants is known as “thiol-Michael reaction.”

As used herein, the term “thiol-ene polymerization” refers to polymerization wherein at least one thiol-ene reaction takes place.

Throughout this disclosure, various aspects of the invention may be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range and, when appropriate, partial integers of the numerical values within ranges. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

### Disclosure

In one aspect, the present invention relates to the unexpected discovery of novel monodisperse microspheres. The microspheres of the invention comprise a polymer prepared using step-growth dispersion click chemistry polymerization.

As described herein, a versatile method for forming micron-size monodisperse microspheres by step-growth polymerization was discovered. In certain embodiments, the use of thiol-click processes allows for the preparation and subsequent functionalization of the microspheres.

In certain embodiments, the microspheres are prepared using thiol-ene polymerization.

Thiol-bearing monomers suitable for embodiments of the present invention include any monomer having thiol (mercaptan or “—SH”) functional groups. Suitable thiol monomers have one, or more than one, functional thiol groups and be of any molecular weight. In certain embodiments, the thiol monomer may be selected from one or more of aliphatic thiols, aromatic thiols, thiol glycolate esters, thiol propionate esters. In other embodiments, suitable thiol bearing monomers include: pentaerythritol tetramercaptopropionate (PETMP); ethylene glycol bis(3-mercaptopropionate) (EGBMP); trimethylolpropane tris(3-mercaptopropionate) (TMPMP); 2,4,6-trioxo-1,3,5-triazina-triy (triethyl-tris (3-mercapto propionate); 1,2-ethanedithiol; 1,3-propanedithiol; 1,4-butanedithiol; 1,5-pentanedithiol; 1,6-hexanedithiol; 1,8-octanedithiol; 1,9-nonanedithiol; 1,11-undecanedithiol; 1,16-hexadecanedithiol; 2,5-dimercaptomethyl-1,4-dithiane; pentaerythritol tetramercaptoacetate; trimethylolpropane trimercaptoacetate; glycol dimercaptoacetate; 2,3-dimercapto-1-propanol; DL-dithiothreitol; 2-mercaptoethylsulfide; 2,3-(dimercaptoethylthio)-1-mercaptopropane; 1,2,3-trimercaptopropane, toluenedithiol; benzenedithiol; biphenyldithiol; benzenedimethanethiol; xylylenedithiol; 4,4′-dimercaptostibene; and glycol dimercaptopropionate.

In certain embodiments, the ene monomers suitable for embodiments of the present invention include any monomer having one, or preferably more reactive “C═C” or “C≡C” groups. In other embodiments, the ene monomer can be selected from one or more compounds having vinyl groups. In yet other embodiments, the ene monomer comprises acrylates or substituted acrylates. In other embodiments, ene monomers suitable for embodiments of the present invention include ethylene glycoldi(meth)acrylate, ethoxylated bisphenol-A dimethacrylate (EBPADMA), tetraethyleneglycoldi(meth)acrylate (TEGDMA), poly(ethylene glycol) dimethacrylates, the condensation product of bisphenol A and glycidyl methacrylate, 2,2′-bis-[4-(3-methacryloxy-2-hydroxy propoxy)-phenyl] propane (BisGMA), hexanediol di(meth)acrylate, tripropylene glycol di(meth)acrylate, butanediol di(meth) acrylate, neopentyl glycol di(meth) acrylate, diethylene glycol di(meth)acrylate, triethylene glycol di(meth) acrylate, dipropylene glycol di(meth)acrylate, trimethylolpropane triacrylate (TMPTA); di(trimethylolpropane) tetraacrylate (DTPTA), divinyl sulfone (DVS), propargyl acrylate, 6-azidohexyl acrylate, [2-(acryloyloxy)ethyl]trimethylammonium chloride, acrylic acid, 2-(4-benzoyl-3-hydroxyphenoxy)ethyl acrylate, 3-sulfopropyl acrylate potassium salt, 2-hydroxyethyl acrylate and 2-(dimethylamino)ethyl acrylate.1,1′-(Methylenedi-4,1-phenylene)bismaleimide, 1,4-di(maleimido)butane, N,N′-phenylenedimaleimide, and N,N′-methylenebisacrylamide.

In certain embodiments, the microspheres are monodisperse. In other embodiments, the microspheres differ in size, shape and/or mass by less than about 50%, 40%, 30%, 20%, 10%, 5%, 2%, or 1%. In certain embodiments, the microspheres differ in size, shape and/or mass by less than about 5%. In certain embodiments, the average diameter of the microspheres is in the range of 0.5 μm to 100 μm. In other embodiments, the average diameter of the microspheres is in the range of 1 μm to 90 μm; in the range of 1 μm to 80 μm; in the range of 1 μm to 70 μm; in the range of 1 μm to 60 μm; in the range of 1 μm to 50 μm; in the range of 1 μm to 40 μm; in the range of 1 μm to 30 μm; in the range of 1 μm to 20 μm; in the range of 1 μm to 10 μmor; or in the range of 1 μm to 5 μm; or in the range of 0.5 μm to 1 μm. In certain embodiments, the microspheres have an average diameter ranging from 1 μm to 10 μm.

In certain embodiments, the glass transition temperature (Tg) of the microspheres can be manipulated by altering the degree of cross-linking In other embodiments, the microspheres included in the present invention have a glass transition temperature(Tg) in the range of −50° C. to 100° C. In certain embodiments, the Tg of microspheres is in the range of of 0° C. to 50° C.; in the range of −50° C. to 50° C.; in the range of −50° C. to 100° C.; or in the range of −24° C. to 16° C.

In certain embodiments, the microspheres are functionalizable, because they comprise unreacted functional groups. In other embodiments, the unreacted functional groups comprises a thiol. In yet other embodiments, the unreacted functional groups comprise a carbon-carbon double bond, such as an electron deficient carbon-carbon double bond. In yet other embodiments, the unreacted functional groups comprise an azide. In yet other embodiments, the unreacted functional groups comprise an alkynyl group.

In certain embodiments, the microspheres can be labeled. In other embodiments, the label comprises a fluorescent molecule, a molecule comprising one or more “clickable” groups, a magnetic moiety (such as iron oxide nanoparticles coated with one or more “clickable groups”), and/or a molecule comprising at least one radioactive isotope. In certain embodiments, the microspheres can be fluorescently labeled. The term “fluorescently labeled” refers to the covalently binding between the microspheres and monomers with fluorescent property, i.e., a fluorophore. In certain embodiments, microspheres with unreacted thiol groups can be reacted with a fluorescent acrylic monomer (acryloxyethylthiocarbamoyl rhodamine B) through a thiol-Michael reaction. In other embodiments, microspheres with unreacted alkyne groups can be reacted with a fluorescent azide (rhodamine 110 conjugated PEG azide) through a copper catalyzed alkyne-azide cycloaddition reaction (CuAAC) reaction in a solvent such as methanol. In yet other embodiments, microspheres with unreacted alkene groups can be reacted with a fluorescent azide (rhodamine 110 conjugated PEG azide) through the copper catalyzed alkyne-azide cycloaddition reaction (CuAAC) reaction in a solvent such as methanol.

In certain embodiments, the microspheres are degradable under controllable conditions. In certain embodiments, the microspheres degrade under acid conditions. In other embodiments, the microspheres degrade under basic conditions. In yet other embodiments, the microspheres degrade when contacted with NaOH aqueous solution, KOH aqueous solution, and/or LiOH aqueous solution. In yet other embodiments, the microspheres degrade when contacted with 1M NaOH aqueous solution.

In certain embodiments, the present invention includes composites comprising microspheres comprising a polymer prepared using step-growth dispersion click chemistry polymerization. In certain embodiments, the polymer in the composite is prepared using thiolene polymerization.

### Methods

The present invention also provides methods of preparing the monodisperse microspheres of the invention. In certain embodiments, a method of the invention comprises contacting a thiol monomer and an ene monomer with an organic solvent, thereby forming a reaction system. In other embodiments, the reaction system further comprises a surfactant. In yet other embodiments, the reaction system further comprises an initiator. In yet other embodiments, the method of the invention comprises promoting the reaction of the thiol monomer and the ene monomer in the reaction system to form a polymer that is insoluble in the reaction system. In yet other embodiments, microspheres comprising the polymer separate as insoluble matter from the reaction system.

In certain embodiments, the reaction system is a homogeneous solution. In certain embodiments, the organic solvent dissolves the monomers but not the resulting polymer, whereby the polymer is complexed by the surfactant to form microspheres and separates from the reaction system. In other embodiments, the organic solvent comprises methanol, ethanol, isopropanol, butanol, a methanol/water mixture, a methanol/hexane mixture, a methanol/heptane mixture, a methanol/cyclohexane mixture, an ethanol/water mixture, an ethanol/hexane mixture, an ethanol/heptane mixture, an ethanol/cyclohexane mixture, ethyl acetate, butyl acetate, acetone, methyl ethyl ketone, acetonitrile, toluene, tetrahydrofuran, 1,4-dioxane; or any mixture of two or more of the above mentioned solvents.

In certain embodiments, the surfactant stabilizes the polymer within the microsphere. In other embodiments, the surfactant comprises polyvinylpyrrolidone, poly(ethylene glycol), poly(vinyl alcohol), poly(styrene-co-maleic anhydride), poly(acrylic acid), poly(vinyl alcohol-co-vinyl acetate), or polyacrylamide.

In certain embodiments, the reaction of the ene monomer and the thiol monomer is promoted by a polymerization photoinitiator, a catalyst and/or radiation.

In certain embodiments, the catalyst comprises an organic amine or phosphine, such as hexylamine, triethylamine, diisopropylethylamine, pyridine, EDAB, 2-[4-(dimethylamino)phenyl]ethanol, N,N-dimethyl-p-toluidine (DMPT), bis(hydroxyethyl)-p-toluidine, triethanolamine, 2,2,6,6-tetramethyl-1-piperidinyloxy, free radical, 2,2,6,6-tetramethylpiperidine 1-oxyl (TEMPO), dimethylphenylphosphine, ethyldiphenylphosphine, triphenylphosphine and the like.

In certain embodiments, the reaction of the ene monomer and the thiol monomer is promoted by a polymerization photoinitiator. In other embodiments, a photoinitiator responsive to visible light is employed. In yet other embodiments, the polymerization photoinitiator is selected from the group consisting of 2,2-dimethoxy-1,2-diphenylethan-1-one, bis(2,4,6-trimethylbenzoyl)-phenylphosphineoxide, 1-hydroxycyclohexyl benzophenone, trimethyl-benzoyl-diphenyl-phosphine-oxide, and combinations thereof. In yet other embodiments, the photoinitiator is a bisacyl phosphine oxide (BAPO). In yet other embodiments, the BAPO photoinitiator is phenyl bis (2,4,6-trimethyl benzoyl) phosphine oxide (Irgacure 819, Ciba). In yet other embodiments, the photoinitiator is a metallocene initiator. In yet other embodiments, the metallocene initiator is Bis(eta 5-2,4-cyclopentadien-1-yl) Bis[2,6-difluoro-3-(1H-pyrrol-1-yl)phenyl]titanium (Irgacure 784, Ciba). In yet other embodiments, if photopolymerization using visible light is desired, camphorquinone (CQ) may be used as an initiator, in combination with an accelerator, such as, for example, ethyl 4-dimethylaminobenzoate (EDAB). Alternatively, if ultraviolet (UV) photopolymerization is desired, then an appropriate UV light activated photoinitiator may be employed. For example, the photoinitiator can be selected from an alpha-hydroxyketone, such as 1-hydroxy-cyclohexylphenylketone (Irgacure 184, Ciba); a benzyldimethyl-ketal, such as 2,2-dimethoxy-2-phenylacetophenone (DMPA, e.g. Irgacure 651, Ciba), or a number of other commercially available photoinitiators may be used as an initiator. Photoinitiators can be used in amounts ranging from about 0.01 to about 5 weight percent (wt %). In one specific embodiment, 0.25 wt % (2,4,6-trimethyl benzoyl) phosphine oxide (Irgacure 819) is used as the photoinitiator. In another specific embodiment, 0.3 wt % CQ is used as an initiator for visible light experiments, along with 0.8 wt % ethyl 4-(dimethylamino)benzoate (commonly known as EDMAB or EDAB). In another specific embodiment, 0.2 wt % DMPA is used as an initiator for UV polymerization.

In certain embodiments, the free radical initiated photopolymerization is photoinitiated by any light wavelength range within the ultraviolet (about 200 to about 400 nm) and/or visible light spectrum (about 380 to about 780 nm). The choice of the wavelength range can be determined by the photoinitiator employed. In certain embodiments, a full spectrum light source, e.g. a quartz-halogen xenon bulb, may be utilized for photopolymerization. In other embodiments, a wavelength range of about 320 to about 500 nm is employed for photopolymerization.

Those skilled in the art will recognize, or be able to ascertain using no more than routine experimentation, numerous equivalents to the specific procedures, embodiments, claims, and examples described herein. Such equivalents were considered to be within the scope of this invention and covered by the claims appended hereto. For example, it should be understood, that modifications in reaction conditions, including but not limited to reaction times, reaction size/volume, and experimental reagents, such as solvents, catalysts, pressures, atmospheric conditions, e.g., nitrogen atmosphere, and reducing/oxidizing agents, with art-recognized alternatives and using no more than routine experimentation, are within the scope of the present application.

It is to be understood that wherever values and ranges are provided herein, all values and ranges encompassed by these values and ranges, are meant to be encompassed within the scope of the present invention. Moreover, all values that fall within these ranges, as well as the upper or lower limits of a range of values, are also contemplated by the present application.

The following examples further illustrate aspects of the present invention. However, they are in no way a limitation of the teachings or disclosure of the present invention as set forth herein.

### EXAMPLES

The invention is now described with reference to the following Examples. These Examples are provided for the purpose of illustration only, and the invention is not limited to these Examples, but rather encompasses all variations that are evident as a result of the teachings provided herein.

### Materials

Unless described otherwise, the materials used in the experiments were obtained from commercial sources or obtained by methods known in the art, and used without further purification.

### Procedure for Preparing Polymeric Composite:

Microspheres made from the PETMPDVS formulation (after washed with methanol for three times, 0.5 g) were put in a vial then a stoichiometric amount of TMPTMP (0.4 g) and TMPTA (0.3 g) was added. The mixture was well mixed and a drop of TEA was added. Then, the mixture was quickly sandwiched into a glass cell with a sample thickness of 1 mm and cured overnight at 70° C.

### Procedure for Preparing Fluorescently Labeled Microspheres:

1.0 g thiol-excess (33 mol %) microspheres were dispersed in 50 mL methanol. 10 mg of acryloxyethyl thiocarbamoyl rhodamine B was then added to the mixture, following by 10 drops of TEA. The mixture was stirring for lh, and then washed with methanol for 5 times.

The functionalization of such microspheres via the CuAAC “click” reaction was started by treating 1.0 g of microspheres with 0.1 g maleic anhydride in methanol in the presence of TEA to consume the unreacted thiol. Then, 1 mg of azide functionalized Cy-5 dye was added along with 10 mg of a copper (II) chloride-PMDTA complex and 100 mg ascorbic acid. The mixture was stirred overnight then washed with methanol 5 times.

### Degradation of Fluorescently-Labeled Microspheres:

0.1 g of rhodamine B labeled thiol excess microspheres were dispersed in 10 mL of 1 mol/L NaOH solution. Specific time point samples were prepared by neutralizing the mixture with ammonia chloride at the desired time, then the mixture was centrifuged, and the upper clear solution was analyzed by UV-vis spectroscopy.

### Fourier Transform Infrared Spectroscopy (FTIR):

FT-IR spectra of microspheres were obtained by a diffuse reflectance FT-IR accessory on a Nicolet 6700. The microspheres were mixed well with KBr powder and mid-IR was utilized to monitor the functional groups in the polymer microspheres.

### Scanning Electron Microscope (SEM):

SEM images were taken on a JEOL JSM 7401F. Dilute suspensions of microspheres in methanol were dropped onto clean glass slides. After the solvent evaporated, samples were coated with approximately 4 nm of gold and then evaluated. The size and size distribution were measured by analyzing SEM images where at least 50 individual microspheres were measured for each sample.

### Fluorescence Microscope:

Fluorescence images were pictured on a Nikon TE-2000-E microscope. Samples consisting of microspheres dispersed in solution were prepared by sealing the solution between a 1″×3″ glass slide and a cover slide with nail polish. The TRITC channel was used for samples labeled with acrylate functionalized rhodamine B, and the YFP channel was used for samples labeled with azide-fluor 488.

Differential Scanning calorimetry (DSC):

Differential scanning calorimetry measurements were performed on a Diamond DSC (Perkin Elmer), calibrated with an indium standard. Two heating cycles of the samples were carried out between −50° C. and 50° C. at 10° C./min, in hermetically sealed aluminum pans. The glass transition temperatures were determined by Pyris software.

### Dynamic Mechanical Analysis (DMA):

Tests were conducted on a TA Instruments Q800 dynamic mechanical analyzer. Samples with thickness of 1 mm were prepared following the method described above. The temperature was ramped at 3° C./min and the frequency used was 1 Hz. The glass transition temperature was determined as the temperature of the maximum value in the tan δ curve.

### UV-Vis Spectroscopy:

A fiber optic UV-Vis spectrometer was used to measure the UV response (USB2000-UV-VIS Miniature Fiber Optic Spectrometer, Ocean Optics, Dunedin, Fla.). Irradiation of samples containing dyes released from the microspheres was achieved by a white light source (ORIEL, fiber optic illuminator model 77501) with a filter that blocks irradiation below 480 nm.

### EXAMPLE 1

### Synthesis

Monodisperse microspheres were successfully prepared by step-growth thiol-Michael addition polymerization. Compared with traditional polymeric microspheres, the nature of step-growth polymerization endorses such microspheres with facilely tunable backbone and intrinsic functionalization.

In one aspect, the method of preparing microspheres according to the present invention comprises preparing a homogeneous mixture comprising a monomer, initiator, surfactant and organic solvent. The reaction media is selected to dissolve monomer but not polymer, so that the polymer precipitates and is stabilized by surfactant to generate microspheres.

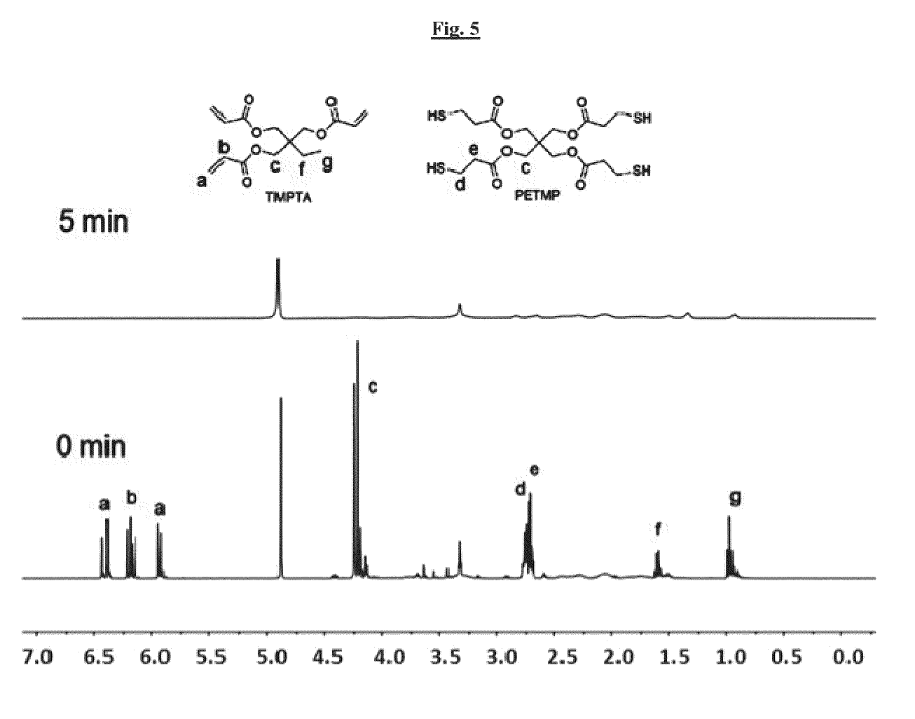

The general dispersion polymerization procedure for thiol-Michael microspheres involves an in situ transition from a homogeneous solution to a heterogeneous colloid. As one non-limiting example, a tetra-thiol (pentaerythritol tetrakis(3- mercaptopropionate; PETMP) and a tri-acrylate (trimethylolpropane triacrylate; TMPTA) were selected as monomers. The monomer mixture [3.66 g (7.5 mmol) PETMP, 3.0 g (10 mmol) TMPTA], along with 1.5 g polyvinylpyrrolidone (PVP) as a surfactant, were dissolved in 150 mL methanol. The mixture was a clear solution until the reaction was triggered by adding under 400 RPM mechanical stirring hexylamine, which is an efficient catalyst for thiol-Michael addition (Wang, et al., ACS Macro Lett., 2012, 1:811-814). Then, the mixture quickly became a white, colloidal dispersion. The polymerization proceeded rapidly and quantitatively with no observable monomer in the solution just 5 min after the reaction was triggered (¹NMR, FIG. 5). The mixture was left stirring for 2 h prior to any additional steps to assure complete conversion. The product was harvested by decantation and/or centrifugation.

The product was isolated as a white powder, after washing with methanol for three times, and dried under vacuum. The yield was measured by weight.

Various polymerization conditions were used for the different monomers and catalyst loadings. For thiol-excess microspheres, 2.0 g TMPTA (6.7 mmol) were used so that the thiol group was present in 33 mol % excess. For the acrylate-excess microspheres, 3.6 g TMPTA (12 mmol) were used so that acrylate was present as a 20 mol % excess. The other polymerization conditions remained the same.

Alkyne functionalized microspheres were made as follows: 2.44 g PETMP (1 eq), 1.8 g TMPTA (0.9 eq), 0.33 g propargyl acrylate (0.15 eq) and 1.5 g PVP were dissolved in 150 mL methanol. The polymerization was triggered by adding 0.1 g TEA. The mixture was allowed to react for 2h under 400 RPM stirring. The product was obtained as a white powder, after washing with methanol for three times, and was subsequently dried under vacuum.

For azide functionalized microspheres, 0.38 g 6-azidohexyl acrylate (0.1 eq) was used instead of propargyl acrylate, and the other conditions were unchanged.

### EXAMPLE 2

### Monodisperse Microspheres and Diameter Manipulation

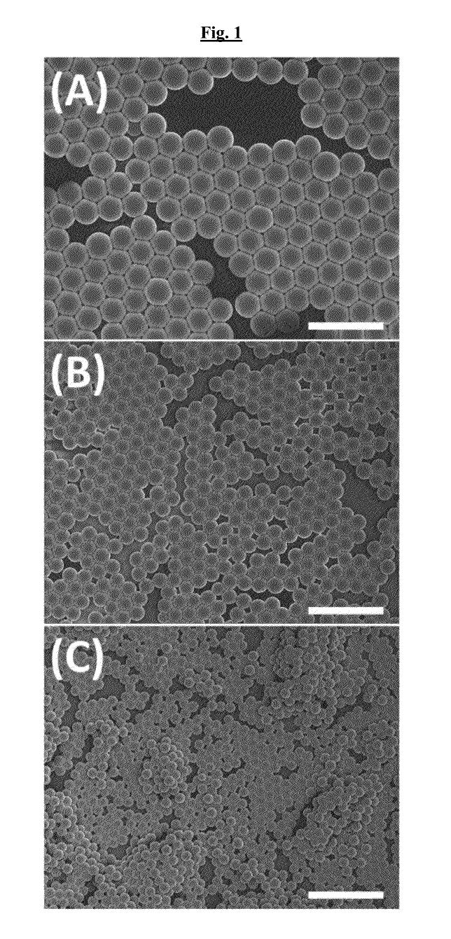

Images from scanning electron microscopy showed that the product consisted of relatively monodisperse, spherical particles (FIG. 1). The product could be re-dispersed in methanol by sonication and re-form a stable colloid, indicating that the microspheres were well isolated from each other. Isolated microspheres indicated that full conversion was achieved, and further reaction was not observed by any means.

Microspheres with varied diameter are achieved by altering the catalyst loading. FIG. 1 illustrate polymerizations initiated with 1.6 wt %, 4.0 wt % and 10.0 wt % hexylamine, resulting in microspheres with diameters of 3.57 mm (Panel A), 2.10 mm (Panel B) and 1.39 mm (Panel C). The coefficients of variance (CV) of the microspheres shown in FIG. 1 are all lower than 5%, indicating monodispersity.

Particle size increases with higher loading of initiator in the dispersion polymerization of styrene. However, in the present invention, the diameter of the microspheres decreased with increasing catalyst concentration in step-growth dispersion polymerization, indicating a fundamentally different particle formation mechanism from the one accepted for free-radical chain-growth dispersion polymerizations.

### EXAMPLE 3

### Physical Properties and Glass Transition Temperatures (T_{g})

In cross-linking step-growth polymerization, the functionality of monomers determines the degree of cross-linking and the physical properties of the polymer network, such as the rubbery modulus and glass transition temperature (T_{g}). A series of monomers of various functionalities were selected to investigate the effects of varied cross-linking densities, as listed in Scheme 1. EGBMP (1), TMPTMP (2) and PETMP (3) are di-, tri- and tetrafunctional thiol monomers; TMPTA (4) and DTPTA (5) are tri and tetra-functional acrylate monomers.

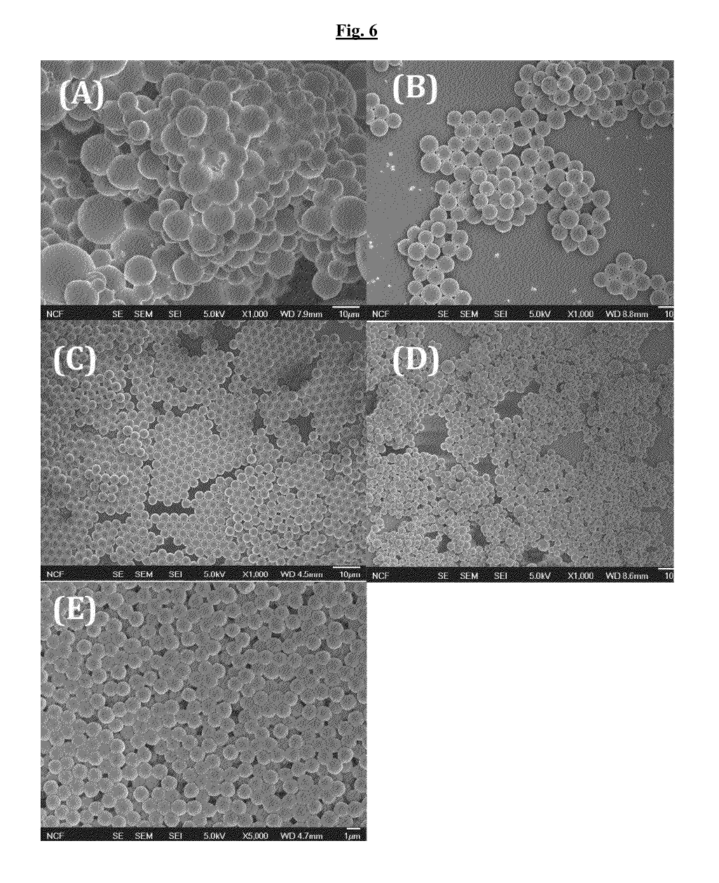

The microspheres prepared by different combinations of these monomers are listed in Table 1 (entries 1-4). All the experiments were conducted under the same levels of functional group concentration (30 mmol for both thiol and acrylate), solvent (150 mL methanol), surfactant (1.5 g PVP), catalyst loading (60 mg hexylamine, 2 mol % to each reactive species) and mechanical stirring (400 rotation per minute). Interestingly, the size and size distribution of the microspheres were strongly dependent on the monomer functionalities. As the number of functional groups increased, the microsphere diameter decreased from 9.87 mm to 2.79 mm (Table 1, entry 1-4, SEM images shown in FIG. 6).

For dispersion polymerization, polymer precipitates when it reaches a critical length/size and forms nuclei. Subsequently, without being bound by any particular theory, the nuclei may react with growing polymeric chains and increase in size uniformly, leading to the desired microspheres. When the degree of functionality increases, the polymer has poorer solubility at a similar conversion. As a result, nucleation starts at lower conversions, and more nuclei are formed. Given that full conversion is still achieved, each nucleus grows with the addition of fewer monomer units with the end result being smaller microspheres. Also, for more cross-linked (i.e., higher functionality) systems, the polymerization mixture became turbid much more quickly. For example, the tetrathiol-tetraacrylate system (Table 1, entry 4) mixture became turbid so quickly that the catalyst was not able to disperse uniformly. As a result, the coefficient of variance increased to 20%, disturbing the falling trend. As demonstrated herein, monodispersity may be achievable for each of these step-growth systems upon optimization.

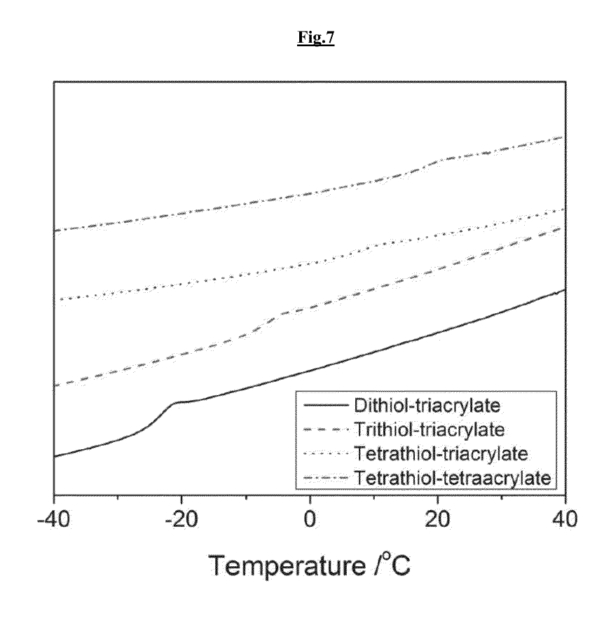

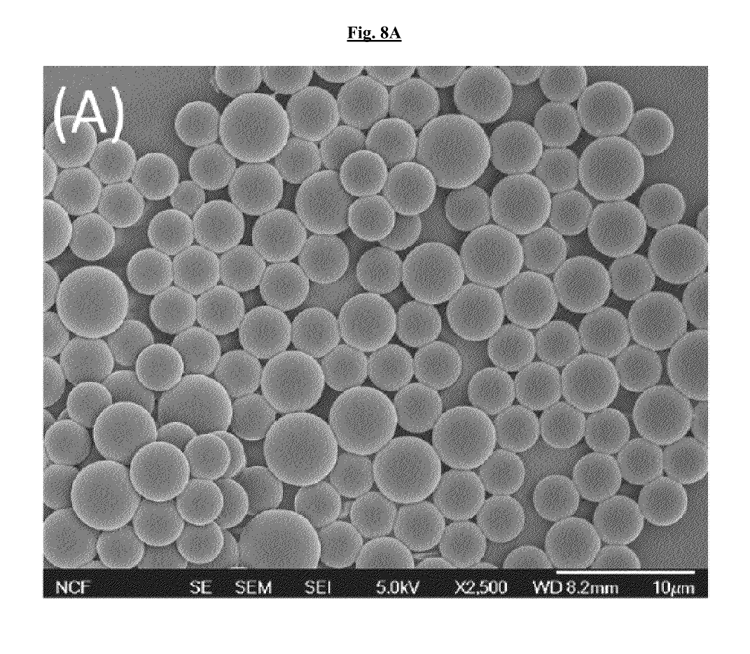

Table 1 demonstrates that the T_{g} is readily manipulated by changing the degree of cross-linking As the crosslink density increased from the dithiol-triene system to the tetrathiol-tetraene resin (entries 1-4 in Table 1), the T_{g} increased from -24° C. to 16° C., as measured by differential scanning calorimetry (DSC, FIG. 7). More interestingly, as the structure of network linking chains was easily tuned in step-growth polymerizations by using different types of vinyl monomer, microspheres with significantly different properties were obtained. For the tetrathiol-diene (entry 5), divinyl sulfone (DVS, Scheme 1(6)) was used as a Michael acceptor. The polymerization conditions for the PETMP-DVS system were analogous to all the other thiol-acrylate systems. However, not only did smaller microspheres result from the PETMP-DVS polymerization, but also their T_{g} was higher than in similarly cross-linked thiol-acrylate network microspheres. The bulky sulfone groups combined with the low molecular weight DVS structure lead to a stiffer backbone polymer chain, which affected the material's T_{g}. As demonstrated herein, this polymerization technique is potentially useful for all kinds of monomers that are applicable to thiol-Michael reactions, and the corresponding properties of such polymer microspheres can be facilely adjusted.

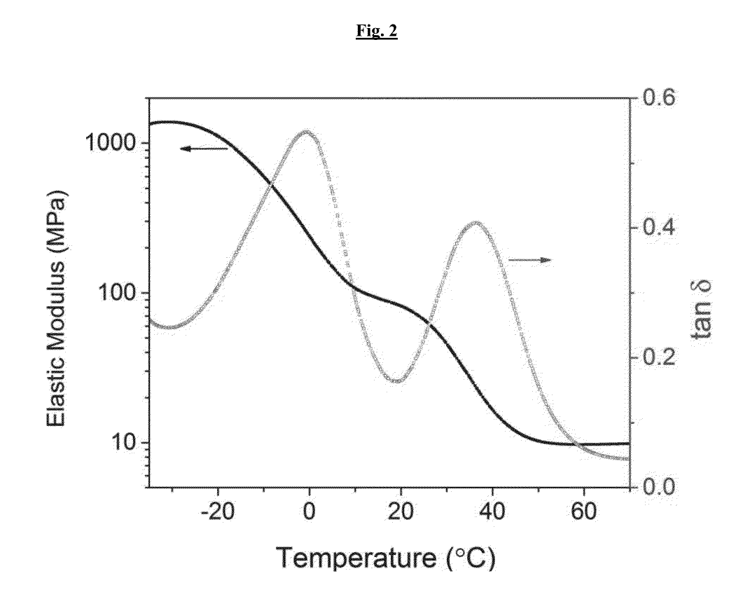

In terms of physical properties, homogeneous networks fabricated by step-growth polymerization have narrow T_{g}'s and robust response to heating. To explore such behavior in microspheres, a microparticle-filled polymeric composite material was prepared by dispersing PETMP-DVS microspheres (40 wt %) well into a mixture of TMPMP-TMPTA monomers (60 wt %), and then polymerized. The composite material was an opaque elastomer at ambient conditions. Its dynamic mechanical analysis (DMA) is shown in FIG. 2. The material exhibits two distinct T_{g}'s: one near 0° C. distinctive of the TMPMP-TMPTA matrix and another near 37° C. from PETMP-DVS microspheres. Both T_{g}'s are higher than those from DSC. The storage modulus dropped from 1400 MPa in the glassy state to 80 MPa after the first transition, and then dropped to 10 MPa after the second one. Both phases in the composite were composed of highly cross-linked polymers. Two distinct Tg's within 40° C. confirmed the homogeneity of step-growth networks and resulted in multiple thermal responses, which could readily be engineered into functional materials such as triple shape memory polymers.

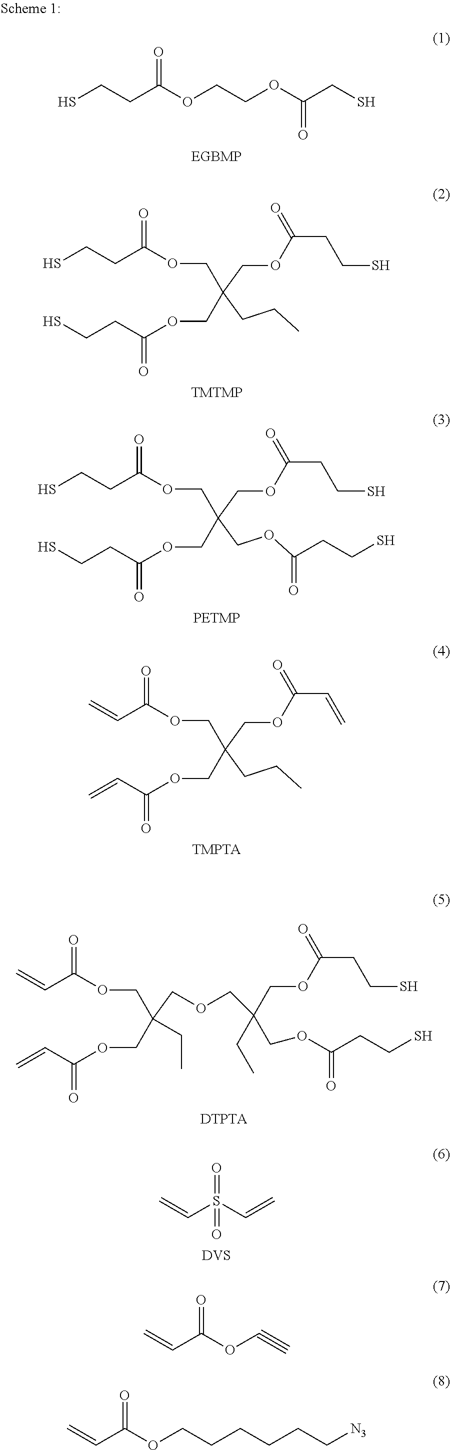

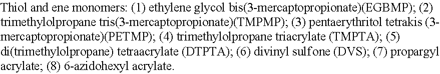

TABLE 1
Dispersion polymerization of multifunctional thiols and
enes^{a} where Dₙ represents the particle diameter, CV represents
the coefficient of variance of the particle diameter,
and Tg is the glass transition temperature.

| | Thiol/ene monomer | | | | |
|---|---|---|---|---|---|
| Entry | functionality^{b} | Dₙ/μm | CV % | Yield/% | T_{g}^{c}/° C. |
| 1 | Di/tri | 9.9 | 36 | 72 | −24 |
| 2 | Tri/tri | 6.1 | 11 | 90 | −6 |
| 3 | Tetra/tri | 3.6 | 3.7 | 94 | 8 |
| 4 | Tetra/tetra | 2.8 | 20 | 90 | 16 |
| 5^{d} | Tetra/di | 1.1 | 4 | 95 | 13 |

^{a}Polymerization conditions: 30 mmol of both thiol and acrylate functional groups, 150 mL MeOH, 1.5 g PVP and 60 mg hexylamine.
^{b}Monomers of varying functionality are shown in Scheme 1.
^{c}The glass transition temperature was measured by DSC.
^{d}Divinylsulfone is used as the ene monomer instead of the acrylate.

### EXAMPLE 4

### Functionalizable Microspheres

In terms of functionalization of polymer microspheres, for example, polystyrene based microspheres, there are usually two ways: post-polymerization reactions that immobilize functional groups onto the surface of microspheres, or copolymerization of functionalizable monomers. The forme method involves multiple steps, whereas the latter is only applicable to functional groups that are inert to radicals. However many useful functionalities are vulnerable to radical reactions.

In contrast, in step-growth polymerization, the thiol-Michael addition is a stoichiometric addition reaction between a thiol and an electron deficient double bond, which enables the preservation of functional groups for off-stoichiometric polymerization. Herein, the present invention provides a facile route to prepare monodisperse functionalizable microspheres, where an excess of either functional group in the reaction is subsequently useful in facilitating functionalization and additional reactions.

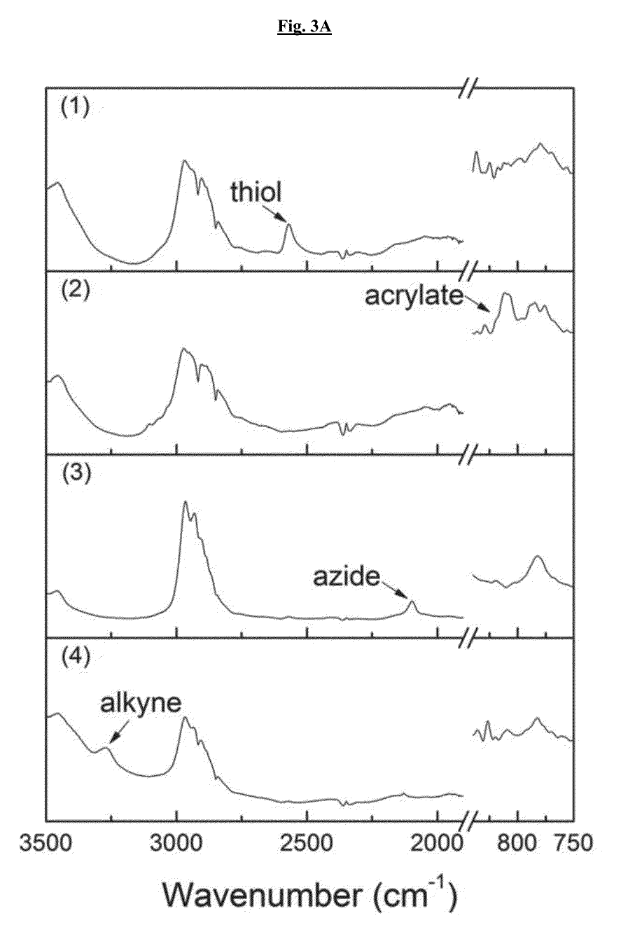

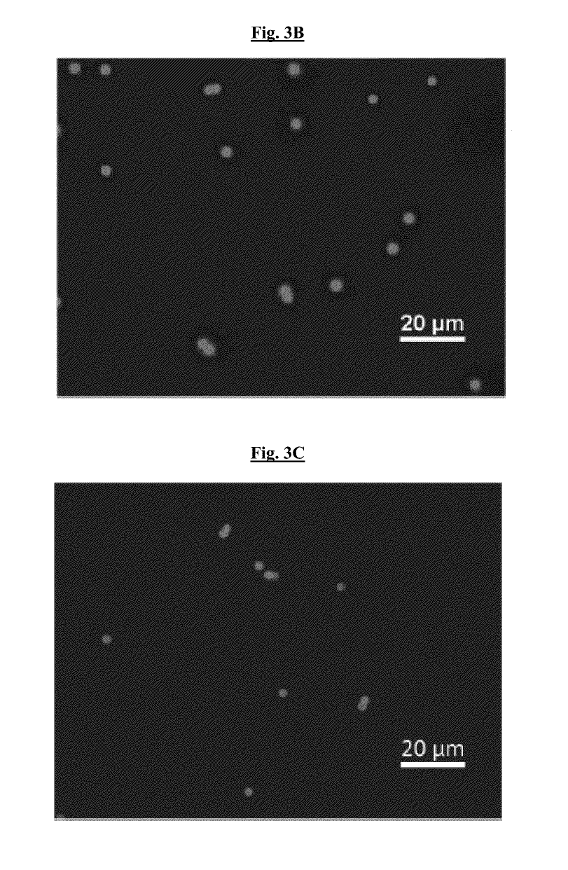

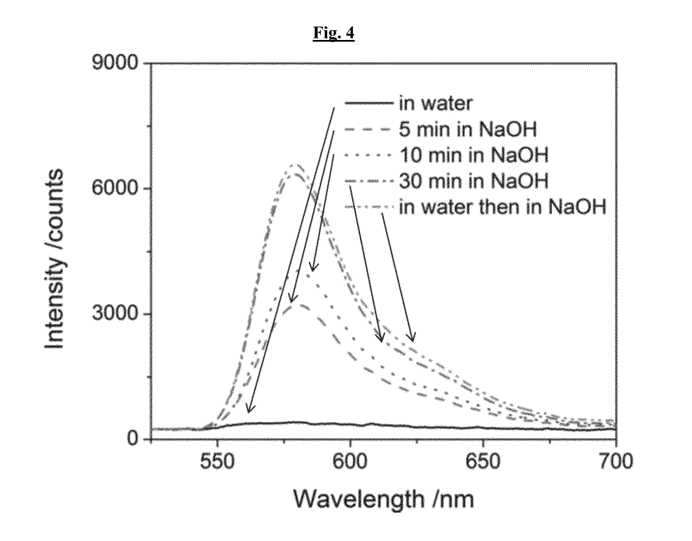

By off-stoichiometric thiol-acrylate polymerization, microspheres with excess thiol (or acrylate) were made in a single, simple step. The residual functionality from the self-limiting reaction was confirmed by FT-IR, as shown in FIG. 3A where the peaks around 2,570 cm⁻¹ and 810 cm⁻¹ identified the thiol and acrylate groups, respectively (FIG. 3A, panels 1-2). Only the excess functionality can be seen on FT-IR, indicating the reaction is indeed stoichiometric, self-limiting and that the polymerization achieves complete conversion of the limiting reactant.

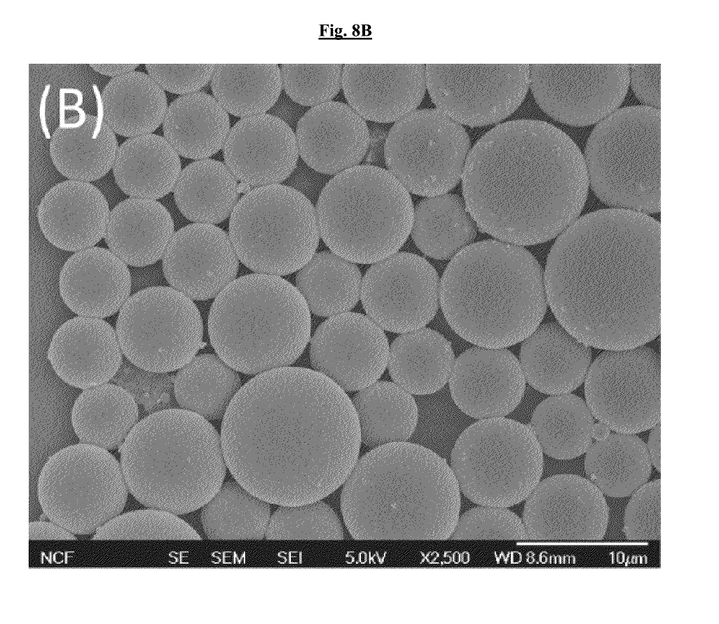

By the way of copolymerization, a variety of functionalities into model thiol-acrylate microspheres were introduced. Alkyne and azide groups were selected as examples, since they are the building blocks for the copper catalyzed alkyne-azide cycloaddition reaction (CuAAC), which has been widely used in bioconjugation and bio-detection analysis. Propargyl acrylate, which is commercially available and 6-azidohexyl acrylate were copolymerized into PETMP-TMPTA based model microspheres (SEM images, FIGS. 8A-8B). FIG. 3A, panels 3-4, shows the confirmation of the azide and alkyne moieties as observed by FT-IR where peaks around 2,100 cm⁻¹ and 3260 cm⁻¹ identified the azide and alkyne, respectively.

### EXAMPLE 5

### Fluorescent Labeling

Functionalizable microspheres may be utilized in fluorescent labeling. To demonstrate the utility of these functionalized microspheres, thiol-excess microspheres were formed and then reacted with a fluorescent acrylic monomer (acryloxyethyl thiocarbamoyl rhodamine B) using a thiol-Michael reaction. In addition, alkyne-functionalized microspheres were reacted with a fluorescent azide (rhodamine 110 conjugated PEG azide) using the CuAAC reaction in methanol. The fluorescence of both thiol-excess and alkyne-functionalized microspheres was confirmed by optical microscopy, as shown in FIGS. 3B-3C, respectively.

### EXAMPLE 6

### Degradable Microspheres

An additional feature of the microspheres in the present invention realtes their controlled degradation. In particular, esters are subject to hydrolysis in acidic and basic environments, allowing for their use in biodegradation and controlled release.

Thiol-acrylate microspheres containing thio-ether esters as building blocks were found to be particularly susceptible to hydrolysis. Such microspheres were dispersed in 1 M NaOH (aq.), and the mixture turned from turbid to clear in just 30 min, indicating particle degradation. More interestingly, fluorescent dye was released during the degradation of microspheres. FIG. 4 shows the amount of fluorophore released as a function of the degradation time for rhodamine B labeled thiol excess microspheres, as monitored by UV-vis spectroscopy. The amount of dye released from the microspheres increased continually with degradation time. Moreover, no dye was released from these same microspheres dispersed in water overnight, because the dye was covalently coupled through a thioether ester functionality.

Subsequent exposure of these particles to a strongly basic solution caused degradation and led to an identical amount of dye release as particles that were immediately placed in basic solution. Clearly, the thiol-Michael reaction allows for varying the chemistry of these microparticles, including their degradation and release characteristics. While relatively harsh conditions were used here to achieve rapid degradation and release, it is readily feasible to degrade these same esters under much more mild conditions, to incorporate more rapidly cleavable esters (or other hydrolytically labile species), or even to include moieties that utilize a different stimulus, e.g., light or heat, to trigger degradation and release.

The disclosures of each and every patent, patent application, and publication cited herein are hereby incorporated herein by reference in their entirety.

While the invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed:

1. Microspheres comprising a polymer which is prepared using step-growth dispersion click chemistry polymerization.

2. The microspheres of claim 1, wherein the click chemistry polymerization comprises at least one selected from the group consisting of thiol-ene polymerization and thiol-Michael polymerization.

3. The microspheres of claim 1, wherein the microspheres have an average diameter within a range selected from the group consisting of: from 0.5 μm to 100 μm, from 1 μm to 50 μm, from 0.5 μm to 1 μm; and from 1 μm to 10 μm.

4. The microspheres of claim 1, wherein the microspheres are selected from the group consisting of near-monodisperse and monodisperse.

5. The microspheres of claim 1, which have a glass transition temperature (Tg) in the range of −50° C. to 100° C.

6. The microspheres of claim 1, which have a Tg in the range of −24° C. to 16° C.

7. The microspheres of claim 1, which have unreacted functional groups which are functionalizable.

8. The microspheres of claim 1, which are degradable in acidic or basic media.

9. The microspheres of claim 1, which are labeled.

10. The microspheres of claim 2,
wherein the thiol monomer is selected from a group consisting of pentaerythritol tetramercaptopropionate (PETMP); ethylene glycol bis(3-mercaptopropionate) (EGBMP);
trimethylolpropane tris(3-mercaptopropionate)(TMPMP); 2,4,6-trioxo-1,3,5-triazina-triy (triethyl-tris (3-mercapto propionate); 1,2-ethanedithiol; 1,3-propanedithiol; 1,4-butanedithiol;
1,5-pentanedithiol; 1,6-hexanedithiol; 1,8-octanedithiol; 1,9-nonanedithiol; 1,11-undecanedithiol; 1,16-hexadecanedithiol; 2,5-dimercaptomethyl-1,4-dithiane, pentaerythritol tetramercaptoacetate, trimethylolpropane trimercaptoacetate, glycol dimercaptoacetate, 2,3-dimercapto-1-propanol, DL-dithiothreitol; 2-mercaptoethylsulfide, 2,3-(dimercaptoethylthio)-1-mercaptopropane, 1,2,3-trimercaptopropane, toluenedithiol, benzenedithiol, biphenyldithiol, benzenedimethanethiol, xylylenedithiol, 4,4′-dimercaptostibene and glycol dimercaptopropionate; and
wherein the ene monomer is selected from a group consisting of ethylene glycoldi(meth)acrylate, ethoxylated bisphenol-A dimethacrylate (EBPADMA), tetraethyleneglycoldi(meth)acrylate (TEGDMA), poly(ethylene glycol) dimethacrylates, the condensation product of bisphenol A and glycidyl methacrylate, 2,2′-bis-[4-(3-methacryloxy-2-hydroxy propoxy)-phenyl]propane (BisGMA), hexanediol di(meth)acrylate, tripropylene glycol di(meth)acrylate, butanediol di(meth) acrylate, neopentyl glycol di(meth) acrylate, diethylene glycol di(meth)acrylate, triethylene glycol di(meth) acrylate, dipropylene glycol di(meth)acrylate, trimethylolpropane triacrylate (TMPTA), di(trimethylolpropane) tetraacrylate (DTPTA), divinyl sulfone (DVS), propargyl acrylate, 6-azidohexyl acrylate, [2-(acryloyloxy)ethyl]trimethylammonium chloride, acrylic acid, 2-(4-benzoyl-3-hydroxyphenoxy)ethyl acrylate, 3-sulfopropyl acrylate potassium salt, 2-hydroxyethyl acrylate and 2-(dimethylamino)ethyl acrylate.1,1′-(Methylenedi-4,1-phenylene)bismaleimide, 1,4-di(maleimido)butane, N,N′-phenylenedimaleimide, and N,N′-methylenebisacrylamide.

11. A polymeric composite comprising microspheres of claim 1.

12. The composite of claim 11, wherein the microspheres have diameters in a range selected from the group consisting of: from 0.5 μm to 100 μm, from 1 μm to 50 μm, from 0.5 μm to 1 μm; and from 1 μm to 10 μm.

13. The composite of claim 11, wherein the microspheres are selected from the group consisting of near-monodisperse and monodisperse.

14. The composite of claim 11, wherein the microspheres's Tg is in the range of −50° C. to 100° C.

15. A method of preparing microspheres, the method comprising the steps of
(a) contacting a thiol monomer and an ene monomer with an organic solvent to form a reaction system, and
(b) promoting the reaction of the thiol monomer and the ene monomer to form a polymer, wherein the polymer is insoluble in the reaction system, whereby the microspheres separate from the reaction system.

16. The method of claim 15, wherein the reaction system further comprises a surfactant.

17. The method of claim 16, wherein the surfactant comprises at least one selected from the group consisting of polyvinylpyrrolidone (PVP), poly(ethylene glycol), poly(vinyl alcohol), poly(styrene-co-maleic anhydride), poly(acrylic acid), poly(vinyl alcohol-co-vinyl acetate), and polyacrylamide.

18. The method of claim 16, wherein the surfactant stabilizes the polymer within the microspheres.

19. The method of claim 15, wherein the microspheres are selected from the group consisting of near-monodisperse and monodisperse.

20. The method of claim 15, wherein the organic solvent comprises methanol, ethanol, isopropanol, butanol, a methanol/water mixture, a methanol/hexane mixture, a methanol/heptane mixture, a methanol/cyclohexane mixture, an ethanol/water mixture, an ethanol/hexane mixture, an ethanol/heptane mixture, an ethanol/cyclohexane mixture, ethyl acetate, butyl acetate, acetone, methyl ethyl ketone, acetonitrile, toluene, tetrahydrofuran, 1,4-dioxane; or any mixture of two or more of the above mentioned solvents.
